(19) United States
(12) Patent Application Publication
(10) Pub. No.: US 2006/0069753 A1
(43) Pub. Date: Mar. 30, 2006

(54) Automatic web-based client-server application program update system

(76) Inventors: Limin Hu, Fremont, CA (US); Ting-Hu Wu, Fremont, CA (US); Ching-Chih J. Han, Fremont, CA (US); Lee J. Magee, San Jose, CA (US)

Correspondence Address: Dergosits & Noah LLP, Suite 1450, Four Embarcadero Center, San Francisco, CA, 94111, US

(21) Appl. No.: 10/871,327

(22) Filed: Jun. 18, 2004

(51) Int. Cl. G06F 15/177

(52) U.S. Cl. 709/220

(57) ABSTRACT

An automated software update method for distributed client/server computers is described. A server process is executed a program on either a standalone computer or a server computer in a distributed client/server network environment. The program updates are either programmed into the server process directly or downloaded to the server in the background. When there is an update to the program, the server forces all client computers executing client-side processes of the server process to shutdown the client process. Alternatively, the server process notifies all clients that an update or maintenance procedure needs to be performed and schedules a disconnect request for all clients. When all clients are disconnected, the server downloads the program updates and performs an automated process to update itself. After the server program is updated, the server allows reconnection of the client computers. When a client computer connects to this server, a client process will automatically perform the update of the client program. This mechanism ensures that all clients and the server will be synchronized with respect to the version of their respective client/server program modules.

### FIELD OF THE INVENTION

The present invention relates generally to computer networks, and more specifically, to an automated software update process for distributed computers in a web-based client/server network.

### BACKGROUND OF THE INVENTION

Client/server systems refer to a computer programming architecture in which one program, the client, makes a service request from another program, the server, which fulfills the request. Although the client/server model can be used by programs within a single computer, it is a much more powerful and useful model in a distributed computer network. In a network, this model provides a convenient way to interconnect programs that are distributed efficiently across different locations.

Client programs request services from a server by sending it a message, and server programs process client requests by performing the tasks requested by clients. Servers are generally passive in that they wait for a client request, but the server must continually run because clients can request service at any time. Client processes, on the other hand, only need to run when they require service. Many server applications allow for multiple clients to request service. To be serviced effectively, the client program must work with the interface or protocol defined by the server. Thus, the server usually defines the interface for communication between the client and server programs. The interface must define how messages are to be sent to the server, what messages are supported, and how messages are to be responded to by the client.

The server process usually comprises several distinct modular components that interact to provide a comprehensive system. For example, a server process can include a message handling mechanism that is modular and distinct from a functional component that processes the request itself. Because of the modular nature of the server process, performing updates or modifications of the functional components of the server can often be done without affecting any of the clients. For example, during the idle periods in which a server is waiting for a client request, the server can perform maintenance tasks or other similar processes. The use of modular programming separates large applications into smaller constituent pieces and facilitates ease of development and provides better maintainability. In a client-server application, a module does not need to be part of the same program or even run on the same computer.

Because software programs are almost never fully developed when released and used, provisions for updating the program while in use, must be accommodated. For a relatively stable program, or for a program used in a low traffic network, the update process is often a non-critical aspect of network operations. However, in a complex distributed environment or a heavy traffic network, this task is often much more difficult and critical. Thus, when developing a client-server application, careful consideration must be given to how modifications, updates, fixes, and so on, are going to be managed during the development and use of the application in a team environment. For comprehensive product development and support, plans for long-term maintenance of the program must be built-in to the initial design of the program.

If a program on the server needs to be updated due to software maintenance, the service provided by the program will often be required to terminate. In this case, the clients cannot be served until the update process is completed. Generally speaking, updates can be of virtually any scale, from simple patches or bug fixes, to comprehensive revision changes or service modifications. Regardless of the complexity of the update, a certain amount of interruption or downtime must be expected. This introduces a delay that can interrupt or stop transactions over the network. Furthermore, the update process may impose a significant burden on the network, for example, if an error occurs during the update process, or if further interfacing between client and server is needed to complete the update. Thus, in many client/server environments, the update process has the potential to add significant processing overhead or critical downtime to the network operation. In certain applications, such as high volume electronic commerce (“e-commerce”) networks, such overhead or delay can actually impose a significant impact on commercial transactions. Although some service providers perform updates at regularly scheduled intervals when they do not expect heavy network traffic (e.g., 2 a.m. every Friday), the increasing globalization of e-commerce networks renders this approach impractical due to the potential for network traffic that can be heavy at almost all hours of the day.

What is needed, therefore, is a software update scheme for client/server networks that minimizes system downtime and provides for seamless program updates across the network.

What is further needed is a client/server program update system that maintains data consistency during software updates.

### SUMMARY OF THE INVENTION

An automated software update method for distributed client/server computers is described. A server process is executed on either a standalone computer or a server computer in a distributed client/server network environment. The program updates are either programmed into the server process directly or downloaded to the server in the background. When there is an update to the program, the server performs an automated process to download the updated program modules, and forces all client computers executing client-side processes of the server process to shutdown the client process. Alternatively, the server process notifies all clients that an update or maintenance procedure needs to be performed and schedules a disconnect request for all clients. When all clients are disconnected, the server updates itself. After the server program is updated, the server allows the client computers to reconnect. When a client connects to the server, a client process automatically performs the update of the client program. This mechanism ensures that all clients and the server will be synchronized with respect to the latest version of their respective client/server programs. The automated software update method embodies a synchronization mechanism for the flexible replacement or revision of software modules over a distributed client/server computer network.

The software update system operates for modular programs executed on a standalone computer in a similar manner for distinct server and client processes. Furthermore, in a distributed network, the software update mechanism operates on mobile as well as desktop or workstation computing devices.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a network for implementing an automatic server process update procedure, according to one embodiment of the present invention;

FIG. 2 is a block diagram that illustrates the general interaction between generic server and client processes for the network illustrated in FIG. 1;

FIG. 3 is a flowchart that illustrates the steps of automatically updating a server process in a distributed client/server network, according to a method of the present invention;

FIG. 4 illustrates a user interface screen of an online user manager process running on a server computer, according to one embodiment of the present invention;

FIG. 5 illustrates a user interface screen of a version manager update tool available on a server computer, according to one embodiment of the present invention; and

FIG. 6 illustrates a user interface screen of a client-side update alert, according to an embodiment of the present invention.

### DETAILED DESCRIPTION OF THE PREFERRED EMBODIMENT

An automated client/server software update system is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, or any other similar type of computing device.

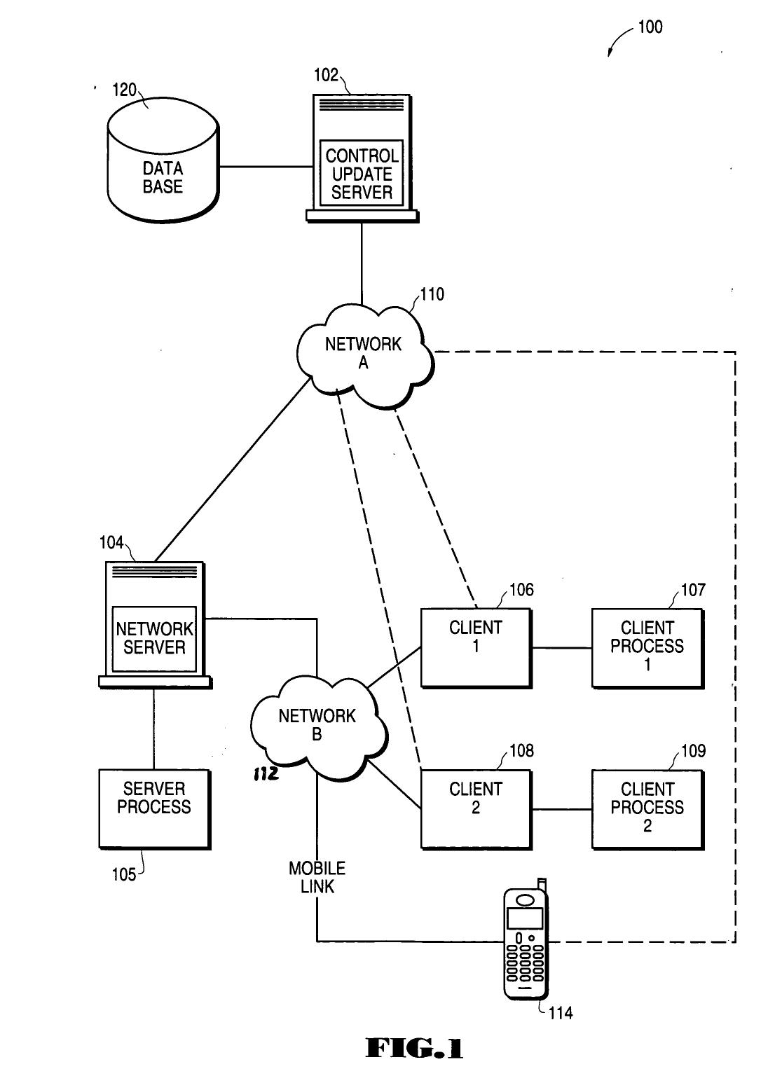

FIG. 1 illustrates an exemplary client/server network system that implements an automated program update and synchronization process, according to one or more embodiments of the present invention. The program to be updated may include operating system software, applications programs, diagnostic tools, communication software, or any other programs that execute on any of the networked computers. The program to be updated may be a standalone program that resides and is executed locally on a computer, or it may be a distributed program that comprises resident modules that are executed on at least two networked computers and may interact with one another to some extent.

In the network embodiment illustrated in FIG. 1, a network server computer 104 is coupled to one or more network client computers 106 and 108 over a network 112. The server computer 104 executes a server process 105, and each of the client computers 106 and 108 execute respective client processes 107 and 109. In typical client/server applications, the server process 105 receives and responds to requests generated by the client processes executed on the client computers 107 and 109. Also coupled to network 112 may be a mobile client 114 that executes a different or mobile version of the client process. The mobile server 114 may be embodied within a portable notebook or PDA class device that is capable of being periodically coupled to network 112 from different remote locations. Network 112 represents a typical corporate local area network (LAN) within a company or facility, or it may be a wide area network (WAN) coupling various client sites. It also may be part of a greater network, such as the Internet.

For a network embodiment in which the client and server computers communicate over the World Wide Web portion of the Internet, the client computers typically accesses the network through an Internet Service Provider (ISP) and execute a web browser program to display web content through web pages. In one embodiment, the web browser program is implemented using Microsoft® Internet Explorer™ browser software, but other similar web browsers may also be used. For this embodiment, server computer 104, executes a web server process that serves web content in the form of web pages to the client computers, and the network that couples the client computers to the server computer comprises the World Wide Web portion of the Internet.

In general, the server and client processes executed by the various computers shown in network 100 must be maintained and kept in synchronization with regard to updates in order for the client/server processes to operate correctly. Depending upon the software architecture of the client/server processes, modules within the server process and/or the client processes may be updated or revised during the lifetime of the programs. These updates must be correctly propagated through the system to ensure that the client/server processes are compatible with one another. The program updates are typically provided by a system administrator or other entity that is responsible for updating the program modules and transmitting the updated modules to each of the computers in the system. For the embodiment illustrated in FIG. 1, a central update server 102 is coupled to the server computer 104. Network 110 may be a private network or it maybe a wide area public access network, such as the Internet. The central update server 102 is the source for the updated or modified programs for the server and/or client processes. The updated programs are made available on the central update server 102 and then downloaded to the appropriate server and/or client computers in the system. The system 100 illustrated in FIG. 1 illustrates a distributed network for keeping each of the server and client computers synchronized with the latest program modules available on the central update server. The central update server provides the necessary synchronization mechanism for keeping the computers up-to-date.

In one embodiment, the updates are provided from the central update server 102 to the client computers through the server 104 and network 112. Alternatively, the updates may be made available directly to the client computers. For this embodiment, the client computers 106 and 108, as well as mobile client 114 may be connected directly to network 110, such as through individual Internet connections. Typically network 110 is a public network (e.g., the Internet), and network 112 is a corporate network, LAN, WAN or a VPN (virtual private network) over a public network. For the embodiment in which all of the clients are connected to network 110, this network may replace network 112 as the local client/server network.

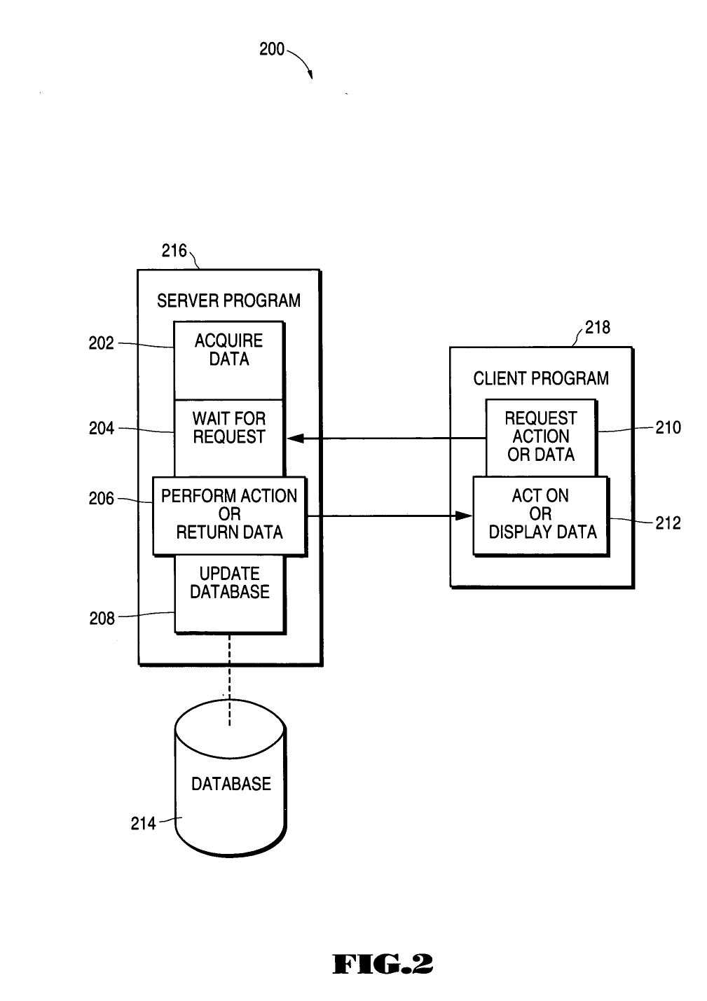

FIG. 2 is a block diagram that illustrates the general interaction between generic server and client processes for the network illustrated in FIG. 1. The server program 216 comprises a number of separate program modules that provide a service for the client program 218. The client program 218 likewise includes a number of program modules that request services from the server process and respond to the requested action. For example, the server program 216 could include a module 202 that acquires and stores data or subprograms that will be used by the client program 218. A separate process 204 runs in the background and waits for requests from the client program. This module is triggered by a counterpart module 210 in client program 218, which requests data or an action from the server program 216. Upon receiving the request, server program module 206 performs the requested action and/or returns the requested data to the client program 218. A counterpart client program module 212 then acts on or displays the data on the client computer. For transactions that impact data accessed by the server, the server program may also include a module 208, which updates a database 214. The database can be loosely or tightly coupled to the server computer 104 on which the server process is executed.

The composition of the client and server processes illustrated in FIG. 2 are intended to be representative of general programs, and not representative of any type of program. Thus, this system 200 can represent any class of client/server processes such as data acquisition software, database search applications, e-commerce applications, industrial control software, and any other distributed or even standalone software application that utilizes a modular and interactive client/server model.

As illustrated in FIG. 2, a typical client/server application can consist of several different modules within the server and client programs. Oftentimes, one or more of these modules may need to be updated during the operational life of the program, that is, while the programs are in use. In order to operate properly, the server and client programs must be in sync with regards to the version of the software that is executed. An update process may be needed to install a new or modified server module and/or a new or modified client module. In certain cases, the entire server and/or client program may need to be updated or replaced. Traditionally, updates would be performed by sending the client users the updated programs on disk or similar media with instructions to install the new programs at a specific time. However, this method has proven to be expensive, clumsy, and unreliable in the increasing environment of large-scale distributed complex client/server applications. The use of network communications and automated processes facilitates the automatic management and installation of program updates. However, certain mechanisms must be in place and executed to ensure that updates occur in a timely and comprehensive manner, and in a way that minimizes interruption of the client and server operations.

Embodiments of the present invention include a synchronization mechanism for performing the replacement or revision of software modules. The server downloads updated program modules to itself at any time and updates its own modules as necessary at appropriate times, such as during idle periods or specified scheduled times. The server downloads the update program modules to the client computers, and forces or otherwise causes the client computers to update their modules as necessary. In general, the client update process can occur in one of four ways. In a first method, the server forces a connected client to update and restart the client process. For this method, after the client computer downloads the updated modules, the server computer sends a command that causes the client computer to suspend operation, update the relevant modules, and then restart the updated processes. This method does not require the disconnection of the client computer from the server computer.

In a second method, the server forces a client computer to update its modules whenever a client tries to connect to the server. In this case, the client can download a patch (small portion of software code) from the server, instead of an entire update program module. In a third method, the server sends an update token to the client its own processes according to the client's schedule, or by a schedule specified in the token. In a fourth method, the client can choose to upload new software modules and update its own processes from the server computer. For this method, the client and server versions of the relevant management software must match to ensure proper upload and update of the client.

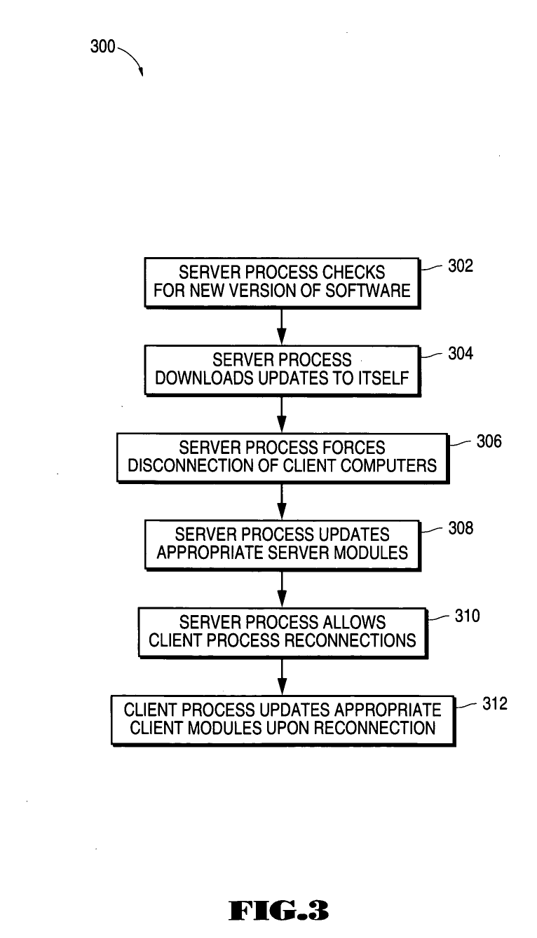

FIG. 3 is a flowchart that illustrates the steps of performing automatic updates in a distributed network, according to one embodiment of the present invention. The network in which the method of FIG. 3 is used may be a multiple client and/or multiple server network, such as the network illustrated in FIG. 1. For the method illustrated in the flowchart of FIG. 3, the program updates are made available on central update server 102. The use of a central system administration computer is a type of arrangement that may be found in e-commerce networks, and the like, in which server functions may be performed by one or more computers distributed throughout the network that are different than the main computer of the program vendor or producer.

In step 302, the server process 105 executed on the server computer 104 checks for whether a new version of any software module for a particular product are available from the system vendor or producer. Although program updates may be loaded directly on the server computer, they may also be available on a separate server, such as the central update server 102, in FIG. 1. This step can be performed by a simple query to a database maintained in the central update server, or by a routine polling operation to an update notification process.

In step 304, the server process 105 downloads the update modules to itself from the central update server 102 for transmission and installation on the client computers. Alternatively, the server process 105 can cause the update modules to be directly downloaded from the central update server to the client computers. In one embodiment, the update download procedure is executed as a background process on the server computer, that is, the modules are loaded onto the server computer while the server executes other tasks.

After the updated modules have been downloaded to the server computer, the server process 105 forces the client computers 106 and 108 to disconnect from the server 104, step 306. In some cases, client disconnection from the network is not necessary. Instead, all that may be required is that the client software be shut down while the update process occurs. If this is the case, the server process 105 will instruct the client user to shut down the client software if it is running so that the appropriate modules can be updated. In a further alternative embodiment, in certain critical networks or under certain circumstances, the disconnection or shutting down of client processes should not be caused by an automated external process. In this case, step 306 can be performed by the server process 105 providing a disconnect request to the client user. This request serves to notify the user that the client should be disconnected from the server or shutdown at a particular time or range of times.

Assuming that one or more program modules on the server computer must be updated, the server process 105 causes the appropriate program modules to be overwritten with the modified code, step 308. After the server modules are updated, the server process 105 then allows the client computers to reconnect to the server 104. If the update procedure requires that one or more client program modules be updated, a client process executed on each client causes the appropriate program modules to be overwritten with the modified code, step 312. By the method illustrated in FIG. 3, synchronization between the server and client versions of a program is maintained through a mechanism that ensures that whenever a client connect to a server, the client software is automatically updated to match the version executed by the server. In general, a client computer or client process can only work with a corresponding server process when the two processes are synchronized with respect to software versions.

In one embodiment of the present invention, each server and client computer can cache the updated program modules in local memory before installing or executing the changed programs.

For network environments in which subnetworks or network connections may be of different speeds or bandwidth capabilities, a token-based distribution scheme may be implemented. For example, some clients to server 104 may be connected to network 112 through an Internet connection, while others may be connected through high-speed LAN/WAN connections. For this embodiment, the network server 104 receives a notice from the central update server 102 that a program update is available. The server 104 then downloads the updated program modules in the background to a local update cache. A previously defined administrative policy or set of rules can be loaded in the server to dictate when the updates are to be applied. This policy can be stored in a database, such as database 120 on the central update server 102, or it may be periodically programmed into the server computer. The server computer 104 checks this administrative update policy to determine whether to apply the update. If the update is to be applied, the server computer 104 sends an update token to the client computers notifying these computers that the server is performing a software update. For example, if the update comprises a version change, the token can specify that the server is updating from version x to version x.1. The token may be embodied within a text message or program script that specifies the version change, as well as instructions as to disconnect/reconnect scheduling, and so on.

The server then forces a disconnection of each of the client computers and updates itself to the new version of the software. With the token system, the client computers can reconnect to the server to perform the update process, or the client computers that have received the token indicating an update can access the central update computer through network 110 directly and download the updated modules from the central update server 102. Alternatively, a client computer can download the update modules to its own update cache prior to receipt of an update token. When the token is received, the cached update is installed on the client computer.

The distributed client/server update system illustrated in method of FIGS. 1 and 3 may be implemented as a web-based process between a server computer 104 executing a web server process and client computers executing a web browser processes. For this embodiment, the interface between the server and client computers is implemented through web pages or web services. Likewise, the program modules to be updated may be web-based modules or web pages maintained by the server 104 and/or the central update server 102.

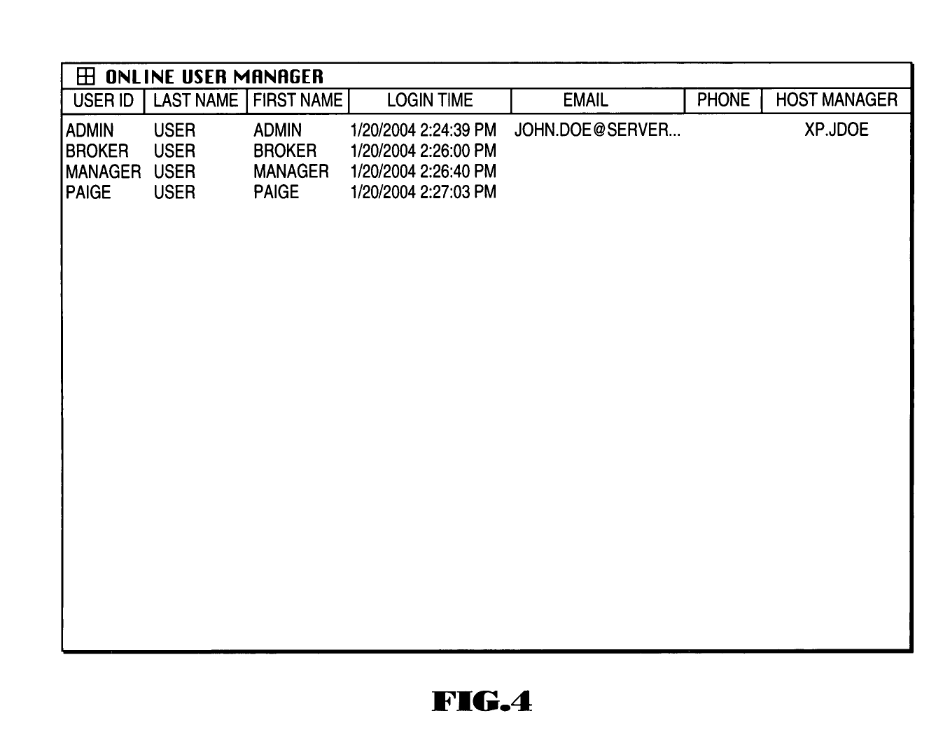

For the embodiment illustrated in FIG. 1, the central update server 102 typically maintains a database and management system for keeping track of networked clients and the status of the relevant software modules on the server and each of the clients. FIG. 4 illustrates a user interface screen of an online user manager process running on a server computer, according to one embodiment of the present invention. The on-line user manager program illustrated in screenshot 400 represents a database of networked clients. Various different fields and data items are available to manage each user. The networked clients are identified by a user identifier (Userid). The database also stores the user's first and last names, as well as other pertinent identification information such as e-mail address, phone number, and so on. The online manager program also tracks the login times of the users and the host server or node, if the network is complex and comprised of branches and subnetworks. The online user manager also stores and manages version data for the various relevant client modules.

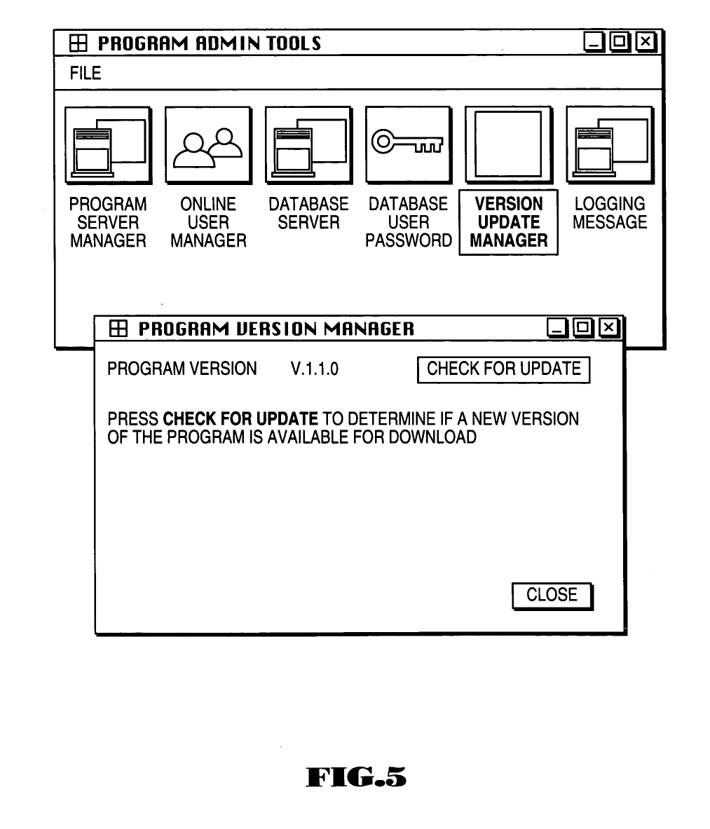

For the embodiment in which update modules are available on a central update server 102 coupled to the server computer 104, the server computer executes a version manager routine that checks for updates available on the central update server. FIG. 5 illustrates a user interface screen of a version manager update tool available on a server computer, according to one embodiment of the present invention. Screenshot 500 illustrates a subwindow that provides access to the executable that determines if a new version of the program or a particular module is available for download. This program within server process 105 will check the latest version number available on the central update server 102 and compare it to present version numbers stored in a database 214. If the version numbers match, no new update is available. If however, a newer version is available, the server process 105 will download the updated program directly to the server 104, or cause the update to be transmitted directly to the client computers.

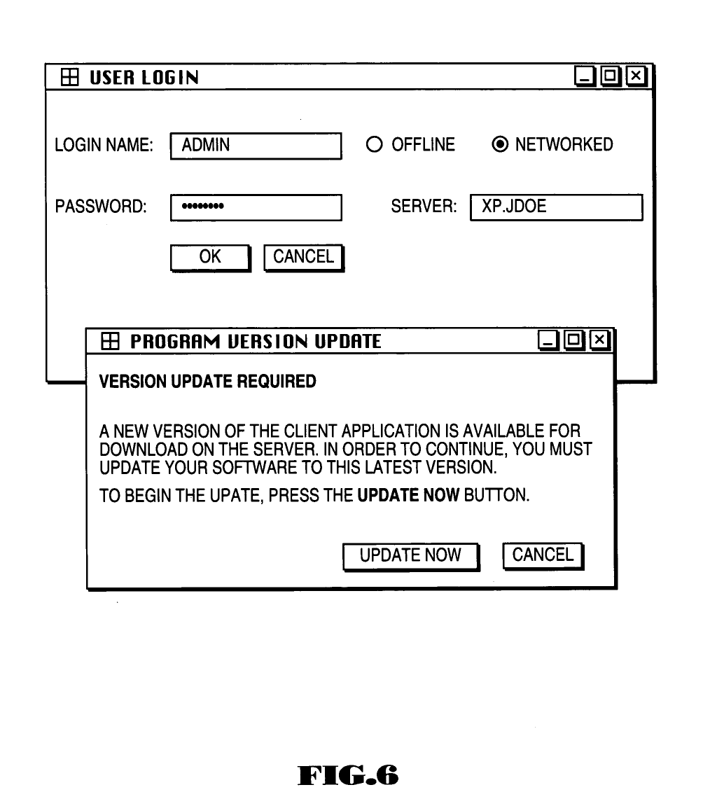

When an update or new version of the client and/or server software is available, the server process 105 will notify the client user of the update. FIG. 6 illustrates a user interface screen of a client-side update alert, according to an embodiment of the present invention. As shown in screenshot 600, upon login, a popup window will be displayed on the client computer indicating that a version update is required. When the user selects the update command, the server process will begin the client disconnect and update module download process illustrated in FIG. 3. After the appropriate modules are downloaded and upon reboot or reconnection of the client computer, the updated modules will be installed by the corresponding server and client programs 216 and 218. At this point, the client/server programs will be properly synchronized with respect to correct version.

Although the embodiment illustrated in FIG. 1 illustrates a network in which the client and server computers are desktop computers, it should be appreciated that either or both of the client and server computers can be embodied within a wide variety of different computing devices, such as workstation class machines, laptops, personal digital assistant (PDA) devices, or any other networkable computing device that can implement client/server software. Likewise, the client/server programs can be embodied within a single computer in a standalone implementation.

In the foregoing, a system has been described for an automatic client/server program update system. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A computer-implemented method for updating program modules executed by a client/server system, the method comprising:
verifying that a new version of a software program is available for installation on a server computer;
downloading updated program modules to the server computer;
causing a client computer coupled to the server computer over a network to disconnect from the server computer;
installing the downloaded program modules on the server computer;
allowing reconnection of the client computer to the server computer; and
installing one or more updated client-side modules on the client computer to ensure version synchronization between a software program executed by the client computer and a corresponding software program executed by the server computer.

2. The method of claim 1 wherein the step of installing the one more updated client-side modules is executed by a client-side process residing on the client computer.

3. The method of claim 1 wherein the step of causing the client computer to disconnect from the server computer includes transmitting a disconnect request from the server computer to the client computer requesting a user to disconnect the client computer from the server computer at a specified time.

4. The method of claim 1 wherein the new version of the program is available on an update server computer coupled to the server computer.

5. The method of claim 1 wherein the server computer and client computer are coupled through the Internet.

6. The method of claim 1 wherein the updated program modules are stored in a cache memory coupled to the server computer.

7. The method of claim 1 wherein the one or more updated client-side modules are stored in a cache memory coupled to the client computer.

8. A computer-implemented method for updating program modules executed by a client/server system, the method comprising:
verifying that a new version of a software program is available for installation on a server computer;
downloading updated program modules to the server computer;
transmitting an update message to a client computer coupled to the server computer over a network;
causing the client computer to disconnect from the server computer;
installing the downloaded program modules on the server computer;
allowing reconnection of the client computer to the server computer; and
installing one or more updated client-side modules on the client computer to ensure version synchronization between a software program executed by the client computer and a corresponding software program executed by the server computer.

9. The method of claim 8 wherein the step of installing the one more updated client-side modules is executed by a client-side process residing on the client computer.

10. The method of claim 9 wherein the step of causing the client computer to disconnect from the server computer includes transmitting a disconnect request from the server computer to the client computer requesting a user to disconnect the client computer from the server computer at a specified time.

11. The method of claim 8 wherein the new version of the program is available on an update server computer coupled to the server computer.

12. The method of claim 8 wherein the server computer and client computer are coupled through the Internet.

13. The method of claim 8 wherein the updated program modules are stored in a cache memory coupled to the server computer.

14. The method of claim 8 wherein the one or more updated client-side modules are stored in a cache memory coupled to the client computer.

15. A computer-implemented method for updating program modules executed by a client/server system, the method comprising:
verifying that a new version of a software program is available for installation on a server computer;
downloading updated program server modules to the server computer;
downloading updated client-side modules to a client computer coupled to the server computer over a network;
installing the downloaded program modules on the server computer;
suspending execution of programs on the client computer that require an update;
transmitting a first command to the client computer to cause installation of the updated client-side modules on the client computer to ensure version synchronization between a software program executed by the client computer and a corresponding software program executed by the server computer; and
transmitting a second command to the client computer to cause execution of programs that include updated client-side modules.

16. The method of claim 15 wherein the steps of transmitting the first command and transmitting the second command are executed by a server-side process residing on the client computer.

17. The method of claim 15 wherein the new version of the program is available on an update server computer coupled to the server computer.

18. The method of claim 15 wherein the server computer and client computer are coupled through the Internet.

19. The method of claim 15 wherein the updated program modules are stored in a cache memory coupled to the server computer.

20. The method of claim 15 wherein the updated client-side modules are stored in a cache memory coupled to the client computer.
